(19) United States
(12) Patent Application Publication
(10) Pub. No.: US 2009/0304367 A1
(43) Pub. Date: Dec. 10, 2009

(54) SYSTEM AND METHOD FOR MEDIA PLAYER DEVICE

(75) Inventors: GENG-LIANG ZHANG, Shenzhen City (CN); YU-ZHANG WEN, Shenzhen City (CN); SHIH-FANG WONG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/346,774

(22) Filed: Dec. 30, 2008

(30) Foreign Application Priority Data
Jun. 4, 2008 (CN) 200810301956.X

(51) Int. Cl. H04N 5/91

(52) U.S. Cl. 386/131

(57) ABSTRACT

A media playing system includes a media player device and an information processing device. The media player device is used for generating a convert request signal indicating a request of a format-converting operation between an original data format and a target data format of a video data in the original data format, and transmitting out the convert request signal and the video data in the original data format; and the information processing device is used for receiving the convert request signal and the video data in the original data format from the media player device, invoking a format-converting program according to the convert request signal to perform the format-converting operation to generate video data in the target data format, and transmitting the video data in the target data format to the media player device.

### BACKGROUND

1. Technical Field

The present disclosure generally relates to information processing technology and, particularly, to system and method for media player devices.

2. Description of Related Art

More and more electronic devices, such as MP3 players, mobile phones, and personal digital assistants (PDAs), provide video playing functions. Some electronic devices not originally designed for playing videos, may have limited functions in terms of video playing and making and editing.

For a mobile phone originally designed for playing video files in Part 14 (MP4) format only, when a video file in a RealMedia Variable Bitrate (RMVB) format is provided, the file should be converted to an MP4 format first. In practice, computers are often used to perform format-converting operations due to their powerful information processing ability. A format-converting operation is performed by user, for example, uploading the video file in the RMVB format to a computer; actuating a format-converting program; converting the RMVB format to the MP4 format by the format-converting program; loading the video file in the MP4 format from the computers to mobile phone. However, this is an inconvenient and time-consuming procedure.

Therefore, new and improved information processing systems and methods for media player devices are desired to overcome the above-described shortcomings.

### SUMMARY

A media playing system is provided. The system includes a media player device and an information processing device. The media player device is used for generating a convert request signal indicating a request of a format-converting operation between an original data format and a target data format of video data in the original data format, and transmitting out the convert request signal and the video data in the original data format; and the information processing device is used for receiving the convert request signal and the video data in the original data format from the media player device, invoking a format-converting program according to the convert request signal to perform the format-converting operation to generate video data in the target data format, and transmitting the video data in the target data format to the media player device. A method of converting video data for a media player device is also disclosed.

Other advantages and novel features will become more apparent from the following detailed description of exemplary embodiment when taken in Page 2 of 21 conjunction with the accompanying drawings.

### BRIEF DESCRIPTION OF THE DRAWINGS

FIG. 1 is a flowchart illustrating a method of video data converting in accordance with an exemplary embodiment.

FIG. 2 is a schematic block diagram showing a media playing system including a media player device in accordance with an exemplary embodiment.

FIG. 3 is a flowchart illustrating an information processing method which can be performed by the media player device of FIG. 2.

### DETAILED DESCRIPTION

In an exemplary embodiment, a media playing system and a method are provided for automatically converting video data file formats. The system mainly includes a media player device and an information processing device, such as a computer.

In a format-converting operation, the media player device automatically generates a convert request signal indicating video data in an original data format and a target data format. Herein, a precondition is determined that the media player recognizes video data in the target file format, yet cannot process video data in the original file format. The media player device transmits the convert request signal and the video data in the original data format to the information processing device (a computer for example) that has been connected to the media player device.

When the information processing device detects the convert request signal and the video data in the original data format, the information processing device searches for a format-converting program installed in the information processing device and invokes the format-converting program to convert the video data in the original data format to the video data in the target data format according to the convert request signal. When the format-converting operation is finished, the information processing device generates a conversion complete signal, and transmits the conversion complete signal and the video data in the target data format to the media player device. The media player device receives the video data in the target data format according to the conversion complete signal. After receiving the video data in the target data format, the media player device can recognize the video data in the target data format and play the video data in the target data format. The media player device may be a mobile phone or an MP3 player.

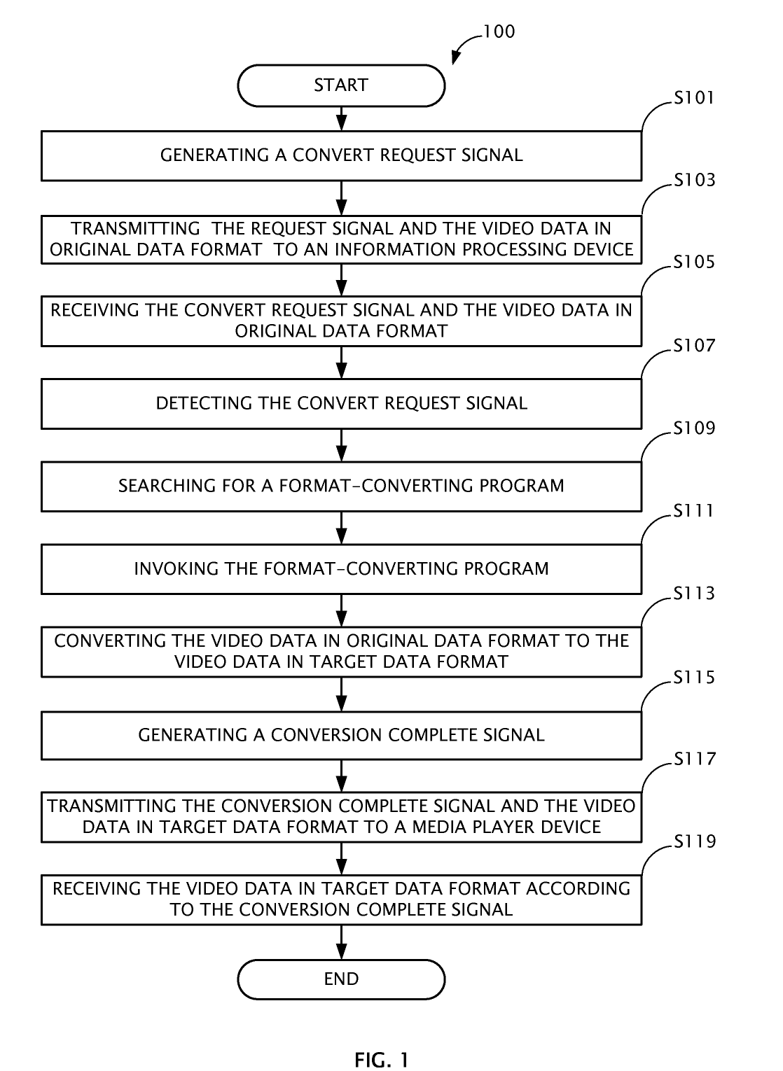

Referring to FIG. 1, a method of video data converting 100 in accordance with an exemplary embodiment is illustrated to accomplish the above mentioned format-converting operation. The method 100 may be implemented by the system including the information processing device and the media player device. The various steps taken in performing the method 100 may be performed in the following presented order. Furthermore, in some embodiments, some steps listed in FIG. 1 may be omitted from the method 100. The method 100 includes the following steps.

Beginning in step S101, the media player device generates a convert request signal for requiring the information processing device to converting the video data in the original data format to the video data in the target data format. In practice, the convert request signal is represented in binary data stream wherein a first part of the binary data stream indicates the video data in the original data format, a second part indicates the target data format, and a third part indicates a request of the format-converting operation. Herein, the video data in the original data format cannot be played, and the video data in the target data format can be played.

In step S103, the media player device transmits the convert request signal and the video data in the original data format to the information processing device that has been connected to the media player device. The information processing device and the media player device may communicate with each other wirelessly using the BLUETOOTH or the Wi-Fi standard.

In step S105, the information processing device receives the convert request signal and the video data in the original data format from the media player device.

In step S107, the information processing device detects the convert request signal.

In step S109, the information processing device searches for a format-converting program according to detected result of the step S107. The detected result indicates the three parts of the convert request signal.

In step S111, the information processing device invokes the format-converting program.

In step S113, the information processing device converts the video data in the original data format to the video data in the target data format by the running format-converting program.

In step S115, when the format-converting operation is finished, the information processing device generates a conversion complete signal.

In step S117, the information processing device transmits the conversion complete signal and the video data in the target data format to the media player device.

In step S119, the media player device begins to receive the video data in the target data format according to the conversion complete signal. After receiving the video data in the target data format, the media player device can play it.

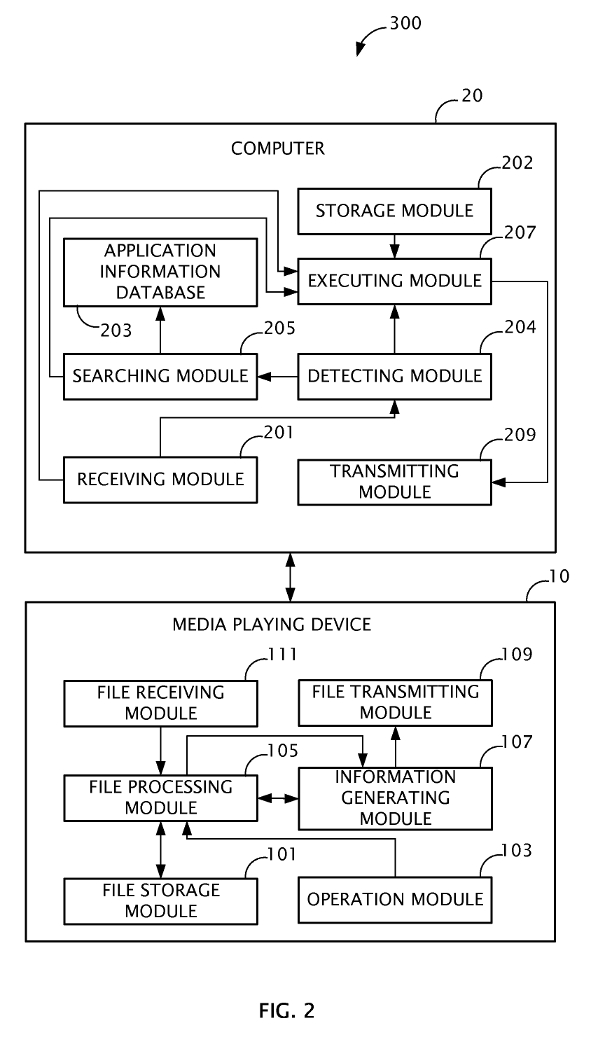

Referring to FIG. 2, an overall information processing system 300 in accordance with an exemplary embodiment includes a media player device 10 and an information processing device 20. The media player device 10 can connect to the information processing device 20 by wireless in BLUETOOTH or Wi-Fi standard. The media player device 10 transmits video data in the original data format to the information processing device 20. The information processing device 20 converts the video data in the original data format to video data in the target data format and generates a conversion complete signal, and transmits the conversion complete signal and the video data in the target data format to the media player device 10. The media player device 10 begins to receive the video data in the target data format according to the conversion complete signal.

The media player device 10 includes a file storage module 101, a operation module 103, a file processing module 105, an information generating module 107, a file transmitting module 109, and a file receiving module 111.

The file storage module 101 is used for storing the video data in the original data format. The video data in the original data format dose not match predetermined format requirements of the media player device 10.

The operation module 103 is used for generating a converting signal used for ordering the information processing device 20 to perform a format-convert operation, and providing the converting signal to the file processing module 105.

The file processing module 105 is used for providing an original data format of the video data in the original data format and a target data format to the information generating module 107, and providing video data in the original data format to the file transmitting module 109.

The information generating module 107 is used for generating the convert request signal composed of the original data format, the target data format, and the converting signal.

The file transmitting module 109 is used for transmitting information including the convert request signal and the video data in the original data format to the information processing device 20 has been connected to the media player device 10.

The file receiving module 111 is used for receiving the video data in the target data format according to the conversion complete signal. After receiving the video data in the target data format, the media player device 10 can play the video data in the target data format.

The information processing device 20 includes a receiving module 201, a storage module 202, an application information database 203, a detecting module 204, a searching module 205, an executing module 207, and a transmitting module 209.

The receiving module 201 is used for receiving the information from the file transmitting module 109 of the media player device 10.

The storage module 202 is used for storing various format-converting programs.

The application information database 203 is used for storing describing information of the format-converting programs. The describing information includes storage addresses of the format-converting programs, information of formats that can be processed by the format-converting programs.

The detecting module 204 is used for detecting whether the information provided by the receiving module 201 includes the convert request signal. When the information provided by the receiving module 201 includes the convert request signal, the detecting module 204 provides the convert request signal to the searching module 205 and the executing module 207, and controls the executing module 207 to receive the video data in the original data format provided by the receiving module 201.

The searching module 205 is used for searching the application information database 203 for describing information of an available format-converting program according to the convert request signal, and providing the describing information to the executing module 207.

The executing module 207 is used for reading the available format-converting program from the storage module 202 corresponding to the describing information provided by the searching module 205, and invoking the format-converting program for converting the video data in the original data format to the video data in the target data format. When the format-converting operation is finished, the executing module 207 generates a conversion complete signal.

The transmitting module 209 is used for transmitting video data in the target data format and the conversion complete signal to the media player device 10.

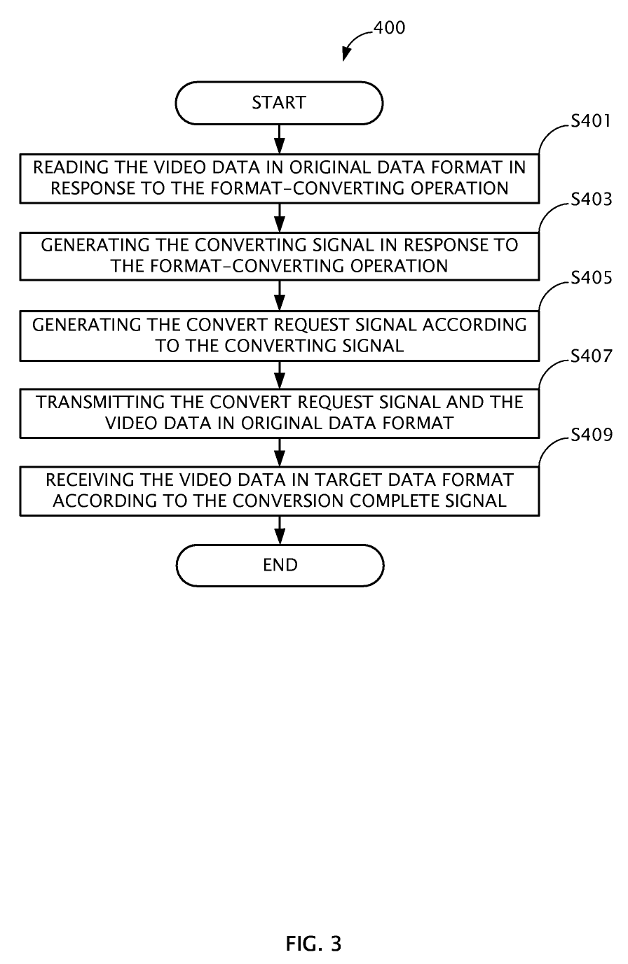

Referring to FIG. 3, a video data converting method 400 of the media player device 10 is illustrated. The method 400 includes the following steps: reading the video data in the original data format in response to the format-converting operation in step S401; generating the converting signal for ordering the information processing device 20 to perform a format-convert operation in step S403; generating the convert request signal composed of the original data format, the target data format, and the converting signal in step S405; transmitting the convert request signal and the video data in the original data format to the information processing device 20 in step S407; receiving the video data in the target data format according to the conversion complete signal in step S409.

As described above, when the media player device 10 can not play the video data in the original data format, the media player device 10 transmits the video data in the original data format to the information processing device 20. The information processing device 20 automatically converts the video data in the original data format to the video data in the target data format, and transmits the video data in the target data format to the media player device 10 for playing.

In practice, an initiative program may be stored in the media player device 10, and will be triggered when a selected video information cannot be reproduced by the media player device 10. The initiative program automatically guides the media player device 10 to operate and transmit the video data in the original data format (the selected video data) and the convert request signal to the information processing device 20. Furthermore, a passive program in response to the initiative program may be stored in the information processing device 20 (a computer for example). The passive program will be triggered when the information processing device 20 receives the video data in the original data format and the convert request signal. The passive program automatically guides the information processing device 20 to accomplish the format-converting operation and transmit the conversion complete signal and the video data in the target data format to the media player device 10. Therefore, it is very convenient for users because all operations of the otherwise manual operations are replaced by the initiative program and the passive program.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A media playing system, comprising:
a media player device capable of generating a convert request signal indicating a request of a format-converting operation between an original data format and a target data format of video data in the original data format, and transmitting out the convert request signal and the video data in the original data format; and
an information processing device capable of receiving the convert request signal and the video data in the original data format from the media player device, invoking a format-converting program according to the convert request signal to perform the format-converting operation to generate video data in the target data format, and transmitting the video data in the target data format to the media player device.

2. The system according to claim 1, wherein the information processing device is further capable of generating a conversion complete signal when the converting operation is finished, and signaling the media player device to receive video data in the target data format via the conversion complete signal.

3. The system according to claim 1, wherein the information processing device and the media player device communicate with each other wirelessly.

4. The system according to claim 1, wherein the information processing device and the media player device communicate with each other wirelessly using the BLUETOOTH standard.

5. The system according to claim 1, wherein the information processing device and the media player device communicate with each other wirelessly using the Wi-Fi standard.

6. The system according to claim 1, wherein the convert request signal is represented in binary data stream that a first part of the binary data stream indicates the original data format, a second part indicates the target data format, and a third part indicates a request of the format-converting operation.

7. A method for converting an original data format to a target data format of video data in the original data format in an information processing device, the method comprising:
generating a convert request signal by a media player device indicating a request of a format-converting operation between the video data in the original data format and video data in the target data format;
transmitting the convert request signal and the video data in the original data format to the information processing device;
receiving the convert request signal and video data in the original data format transmitted by the media player device;
invoking a format-converting program in response to the convert request signal;
converting the video data in the original data format to video data in the target data format by the format-converting program;
transmitting the video data in the target data format to the media player device.

8. The method according to claim 7, further comprising:
generating a conversion complete signal when the converting operation is finished;
transmitting the conversion complete signal to the media player device;
receiving the video data in the target data format according to the conversion complete signal.

9. The method according to claim 7, wherein the information processing device and the media player device may communicate with each other wirelessly.

10. The method according to claim 9, wherein the information processing device and the media player device may communicate with each other wirelessly using the BLUETOOTH standard.

11. The method according to claim 9, wherein the information processing device and the media player device may communicate with each other wirelessly using the Wi-Fi standard.

12. The method according to claim 7, wherein the convert request signal is represented in binary data stream that a first part of the binary data stream indicates the original data format, a second part indicates the target data format, and a third part indicates a request of the format-converting operation.

13. A medium having stored thereon programs that, when executed by a video playing apparatus of an information processing system, cause the video playing apparatus to:
read video data in the original data format from a file storage module of the video playing apparatus;
provide an original data format and a target data format of the video information;
generate a convert request signal composed of the original data format and the target data format for cause a computer to execute a format-converting operation of the information processing system;
transmit the convert request signal and the video data in the original data format to the computer.

14. The medium according to claim 13 further comprises some programs that, when executed by the computer, cause the computer to:
receive the convert request signal and the video data in the original data format;
invoke a format-converting program according to the convert request signal to perform the format-converting operation to generate video data having the target data format;
transmit the video data having the target data format to the video playing apparatus.

15. The medium according to claim 14 further comprises some programs that, when executed by the computer, cause the computer to:
generate a conversion complete signal when the converting operation is finished;
transmit the conversion complete signal to the video playing apparatus.

16. The medium according to claim 15 further comprises some programs that, when executed by video playing apparatus, cause the video playing apparatus to receive the video information having the target data format according to the conversion complete signal.

17. The medium according to claim 13, wherein the video playing apparatus and the computer communicate with each other wirelessly.
